(19) United States
(12) Patent Application Publication
(10) Pub. No.: US 2002/0120853 A1
(43) Pub. Date: Aug. 29, 2002

(54) Scripted distributed denial-of-service (DDoS) attack discrimination using turing tests

(75) Inventor: David Spencer Tyree, Reston, VA (US)

Correspondence Address: Edward A. Pennington Esq., SWIDLER BERLIN SHEREFF FRIEDMAN, LLP, 3000 K Street, Suite 300, Washington, DC, 20007, US

(73) Assignee: NETWORKS ASSOCIATES TECHNOLOGY, INC.

(21) Appl. No.: 09/793,733

(22) Filed: Feb. 27, 2001

(51) Int. Cl. G06F 11/30

(52) U.S. Cl. 713/188

(57) ABSTRACT

A system, method and computer program product can include a test performed by a computer to determine whether a requestor of resources is a human user or a computer software scripted agent. If the test is passed, then the computer of the present invention assumes that the requestor of resources is a valid human user and access to resources is granted. In an exemplary embodiment of the present invention a system, method and computer program product for controlling access to resources. In an exemplary embodiment the method can include the steps of receiving a request from an entity; presenting the entity with a test; determining from the test whether or not the entity is an intelligent being; and granting the request only if the entity is determined to be an intelligent being.

### BACKGROUND OF THE INVENTION

1. Field of the Invention

The present invention related generally to network security tools, and more particularly with network security tools for dealing with denial of service attacks.

2. Related Art

A “denial-of-service” (DoS) attack is characterized by an explicit attempt by multiple attackers to prevent legitimate users of a service from using that service. Examples include, e.g., attempts to “flood” a network, thereby preventing legitimate network traffic from gaining access to network resources; attempts to disrupt connections between two machines, thereby preventing access to a service; attempts to prevent a particular individual from accessing a service; and attempts to disrupt service to a specific system or person.

Not all service outages, even those that result from malicious activity, are necessarily denial-of-service attacks. Other types of attack may include denial-of-service as a component, but the denial-of-service may be only part of a larger attack.

Illegitimate use of resources may also result in denial-of-service. For example, an intruder may use an anonymous file transfer protocol (FTP) area of another user as a place to store illegal copies of commercial software, consuming disk space and generating network traffic.

Denial-of-service attacks can disable a server or network of an enterprise. Depending on the nature of the enterprise, such as, e.g., an Internet portal or electronic commerce (e-commerce) site, a denial-of-service attack can effectively disable an entire organization.

Some denial-of-service attacks can be executed with limited resources against a large, sophisticated site. This type of attack is sometimes called an “asymmetric attack.” For example, an attacker with an old PC and a slow modem may be able to disable much faster and more sophisticated machines or networks.

Denial-of-service attacks can conventionally come in a variety of forms and aim to disable a variety of services. The three basic types of attack can include, e.g., (1) consumption of scarce, limited, or non-renewable resources; (2) destruction or alteration of configuration information; and (3) physical destruction or alteration of network components.

The first basic type of attack seeks to consume scarce resources recognizing that computers and networks need certain things to operate such as, e.g., network bandwidth, memory and disk space, CPU time, data structures, access to other computers and networks, and certain environmental resources such as power, cool air, or even water.

Attacks on network connectivity are the most frequently executed denial-ofservice attacks. The attacker's goal is to prevent hosts or networks from communicating on the network. An example of this type of attack is a “SYN flood” attack.

Attacks can also direct one's own resources against oneself in unexpected ways. In such an attack, the intruder can use forged UDP packets, e.g., to connect the echo service on one machine to another service on another machine. The result is that the two services consume all available network bandwidth between the two services. Thus, the network connectivity for all machines on the same networks as either of the targeted machines may be detrimentally affected.

Attacks can consume all bandwidth on a network by generating a large number of packets directed to the network. Typically, the packets can be ICMP ECHO packets, but the packets could include anything. Further, the intruder need not be operating from a single machine. The intruder can coordinate or co-opt several machines on different networks to achieve the same effect.

Attacks can consume other resources that systems need to operate. For example, in many systems, a limited number of data structures are available to hold process information (e.g., process identifiers, process table entries, process slots, etc.). An intruder can consume these data structures by writing a simple program or script that does nothing but repeatedly create copies of the program or script itself. An attack can also attempt to consume disk space in other ways, including, e.g., generating excessive numbers of mail messages; intentionally generating errors that must be logged; and placing files in anonymous ftp areas or network shares. Generally, anything that allows data to be written to disk can be used to execute a denial-of-service attack if there are no bounds on the amount of data that can be written.

An intruder may be able to use a “lockout” scheme to prevent legitimate users from logging in. Many sites have schemes in place to lockout an account after a certain number of failed login attempts. A typical site can lock out an account after 3 failed login attempts. Thus an attacker can use such a scheme to prevent legitimate access to resources.

An intruder can cause a system to crash or become unstable by sending unexpected data over the network. The attack can cause systems to experience frequent crashes with no apparent cause.

Printers, tape devices, network connections, and other limited resources important to operation of an organization may also be vulnerable to denial-of-service attacks.

The second basic type of attack seeks to destruction or alteration configuration information, recognizing that an improperly configured computer may not perform well or may not operate at all. An intruder may be able to alter or destroy configuration information that can prevent use of a computer or network. For example, if an intruder can change routing information in routers of a network then the network can be disabled. If an intruder is able to modify the registry on a Windows NT machine, certain functions may be unavailable.

The third basic type of attack seeks to physically destroy or alter network components. The attack seeks unauthorized access to computers, routers, network wiring closets, network backbone segments, power and cooling stations, and any other critical components of a network.

Distributed Denial-of-Service Attacks

FIG. 1 depicts an exemplary distributed denial of service (DDoS) attack 100. DDoS attacks 100 occur when one or more servers 102a, 102b are attacked by multiple attacking clients or agents 104 over a network 108. Expanding on early generation network saturation attacks, DDoS can use several launch points from which to attack one or more target servers 102. Specifically, as shown in FIG. 1, during a DDoS attack, multiple clients, or agents 104a-104f, on one or more host computers 112 can be controlled by a single malicious attacker 106 using software referred to as a handler 110. Prior to launching a DDoS attack, the attacker 106 can first compromise various host computers 112a-112f potentially on one or more different networks 108, placing on each of the host computers 112a-112f, one or more configured software agents 104a-104f that can include a DDoS client program tool such as, e.g., “mstream” having a software trigger that can be launched from a command by the intruder attacker 106 using the handler 110. Usually the agents 104 are referred to as “scripted agents” since they perform a serious of commands according to a script. The goal of the attacker 106 is to overwhelm the target server or servers 102a, 102b and to consume all of the state and/or performance resources of the target servers 102a, 102b. For example, state resources can include, e.g., resources maintaining information about clients on the server. Also, an example performance resource can include, e.g., a server's ability to provide 2000 connections per second. The attacker 106 typically attempts to deny other users access by taking over the use of these resources.

Conventional proposed solutions to DoS unfortunately fall short in addressing DDoS attacks have significant shortcomings. There are presently no solutions that can stop a DDoS attack. One solution that has been proposed includes tracing back through network 108 from the victim server 102a, 102b to an originating client computer 112a-112f and disabling the client 112a-112f. A traceback in theory would originate from the server 102, 102b and would trace back through each router that an IP message traversed. Unfortunately, there is no conventional way of tracing which routers a packet has traveled through. There is no way to trace back through all the heterogeneous routers (e.g., running multiple non-uniform routing protocols). Even if one could modify all the routers on the Internet to permit tracing a packet back from a server, there is no readily usable means of disabling or cutting off the sending of messages from the attacking client 112a-112f.

Another conventional solution, attempts to filter out requests from invalid users. If a request is identified as being an invalid request, then such requests can be filtered. If the request is determined to come from an invalid user, then the request can be blocked or filtered. This solution, although usable in some contexts today, is anticipated to be easily worked around by evolving attackers. Conventional attackers may in some cases be relatively easily distinguished from legitimate user requests. However, as attacks evolve, it is anticipated that attack requests could more closely mimic legitimate users in behavior making identification of invalid users practically impossible. For example, it is expected that attackers will evolve to send requests that so closely mimic legitimate users as to be indiscernible from valid user requests. Specifically, e.g., an attacker could fill dummy information into a form that could cause a request to be made that is conventionally indistinguishable from a legitimate user request filling out the same form. Thus, conventional solutions are at best only temporarily effective and provide no long-term protection from such attacks.

It is desirable that prior to and during a DDoS attack, that attackers from valid users be distinguished from attacking users. For example, to overcome a DDoS attack it is desirable that valid users be distinguished from attack agents. If it is possible to determine which requests are valid and which requests are invalid, then legitimate user requests can be distinguished from requests from the attackers. Unfortunately, if a means to distinguish between valid and invalid users is discovered, then the attackers will in time circumvent the method of distinguishing between users.

For example, if ICMP traffic to an attacked system is intentionally limited to avoid attack, then the attacker may move to using hypertext transport protocol (HTTP) or web browser traffic to attack a system. This can compound the difficulty of determining valid from invalid traffic. Unfortunately the attacker can configure agents that can mimic valid traffic, making the process of distinguishing between valid and invalid user requests very difficult.

What is needed is an improved method of distinguishing between requests from valid and invalid users that overcomes shortcomings of conventional solutions.

### SUMMARY OF THE INVENTION

In an exemplary embodiment of the present invention a system, method and computer program product for controlling access to resources. In an exemplary embodiment the method can include the steps of (a) receiving a request from an entity; (b) presenting the entity with a test; (c) determining from the test whether or not the entity is an intelligent being; and (d) granting the request only if the entity is determined to be an intelligent being.

In one exemplary embodiment, step (a) can include (1) receiving a request for system resources from the entity. In one exemplary embodiment, step (1) can include (A) receiving a request for services, access or resources from the entity.

In one exemplary embodiment, step (b) can include (1) presenting the entity with an intelligence test. In one exemplary embodiment, step (1) can include (A) presenting the entity with a Turing test, a nationality test, or an intelligence test. In one exemplary embodiment, step (A) can include (i) presenting the entity with a 2D or 3D graphical image, language, words, shapes, operations, a sound, a question, a challenge, a request to perform a task, content, audio, video, and text.

In one exemplary embodiment, steps (a-d) can comprise a second level of security, and a first level of security can include (1) filtering the request for known invalid requests.

In one exemplary embodiment, step (a) can include (1) receiving a request from a protocol providing potential for intelligent being interaction including http, ftp, smtp, chat, IM, IRC, Windows Messaging protocol, or an OSI applications layer application.

In one exemplary embodiment, step (d) can include (1) denying access to the request for scripted agents during a distributed denial of service attack and invalid entities.

In one exemplary embodiment, the method can further include (e) updating the test to overcome advances in artificial intelligence of agents. In one exemplary embodiment, step (e) can include (1) providing a subscription to test updates.

In one exemplary embodiment, the method can further include (e) generating the test including (1) generating a test and an expected answer, and (2) storing an expected answer for comparison with input from the entity.

In an exemplary embodiment, the system that controls access to resources can include a processor operative to receive a request from an entity, to present the entity with a test, and to grant the request only if the test determines whether the entity is an intelligent being.

In an exemplary embodiment, the request can include a request for network access; network services; or computer system storage, processor resources, or memory resources. In one exemplary embodiment the test can include an intelligence test, a nationality test, a Turing test, language, words, shapes, operations, content, audio, video, sound, a 2D or 3D graphical image, text, a question, and directions to perform at least one of an action and an operation.

In one exemplary embodiment, the test can be a second level of security, and the system can further include a first level of security having a filter that identifies invalid requests.

In one exemplary embodiment, the system can further include an update that provides updated tests that overcome advances in artificial intelligence of agents.

In one exemplary embodiment, the system can further include a random test generator that determines an expected answer to the test; a memory that stores the expected answer; a test generator that renders the test; and a comparator that compares the expected answer with an answer to a question inputted by the entity in response to the test. In an exemplary embodiment, the expected answers can be encrypted. In another exemplary embodiment, the encrypted expected answers can be sent to the entity. In yet another exemplary embodiment, the expected answers can be represented in another fashion to the entity.

In one exemplary embodiment, the computer program product can be embodied on a computer readable media having program logic stored thereon that controls access to resources, the computer program product comprising: program code means for enabling a computer to receive a request from an entity; program code means for enabling the computer to present the entity with a test; program code means for enabling the computer to determine from the test whether or not the entity is an intelligent being; and program code means for enabling the computer to grant the request only if the entity is determined to be an intelligent being.

In one exemplary embodiment, the system can control access to resources and can include a firewall including a processor operative to receive a request for resources from an entity, to present the entity with a test, and to grant the request for resources only if the test determines whether or not the entity is an intelligent being.

According to an exemplary embodiment, to avoid a DDoS attack, requests from an attacker can be distinguished from requests from valid users using a test according to the present invention. The test of the present invention can distinguish valid users from attack agents, where the attack agents can be scripted attack agents. The present invention can determine which requests are valid and which requests are invalid and then can allow legitimate user requests to pass to the requested server resource.

The present invention anticipates that in an exemplary embodiment, if valid and invalid users can be discovered, then the attacker in time may be able to circumvent the method of distinguishing between users. For example, if ICMP traffic to an attacked system is intentionally limited to avoid attack, then the attacker may move to using hypertext transport protocol (HTTP) or web browser requests to attack a system. This eventuality compounds the difficulty of determining valid from invalid traffic. Unfortunately, future attackers may be able to configure agents that can closely mimic valid traffic, making distinguishing between valid and invalid user requests very difficult.

In an exemplary embodiment of the present invention, an intelligence test can be used to distinguish between a valid and invalid request for resources during a denial of service attack. In an exemplary embodiment of the intelligence test is a Turing test.

According to an exemplary embodiment of the present invention, during an attack, valid users can be distinguished from invalid users by presenting the users an intelligence test. The users can then be prompted for a response that can discriminate between intelligence and non-intelligence.

In an exemplary embodiment, during a DDoS attack, the intelligence test can include a web page including a message. In an exemplary embodiment, the message can be displayed to each user prompting the user for input. In one exemplary embodiment, the message can ask the user to solve a problem that can be simple, such as “Please type the third word in this sentence?” The user can respond to the message and the present invention can determine whether the user passed the test. In an exemplary embodiment, if the user passes the test, then the user can be validated. Otherwise, the user can remain invalid and can, in an exemplary embodiment be prevented from accessing the site under attack.

In another exemplary embodiment, to further discriminate valid from invalid users, messages including other types of content could be used. In an exemplary embodiment, the user can be presented with a message including any of various types of content including, e.g., languages, words, shapes, graphical images, operations, 3D objects, video, audio, and sounds. In the exemplary embodiment, the user can then be asked some questions about the content. In an exemplary embodiment, the type of authentication can be varied using, e.g., a random selection from the media types and questions. Advantageously, the authentication of the present invention, including an intelligence test, does not need to be be protocol specific. The present invention can be used, e.g., with any of a number of standard protocols. For example, a hyper-text transport protocol (HTTP) authentication could include a simple form. Meanwhile, a file transfer protocol (FTP) could present the user with a second login asking a simple question. In another exemplary embodiment, a simple mail transport protocol (SMTP) could email the user a question and could await an expected reply.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The left most digits in the corresponding reference number indicate the drawing in which an element appears first.

### BRIEF DESCRIPTION OF THE DRAWINGS

The foregoing and other features and advantages of the invention will be apparent from the following, more particular description of a preferred embodiment of the invention, as illustrated in the accompanying drawings:

FIG. 1 depicts an exemplary embodiment of a distributed denial of service (DDoS) attack of a server over a network by multiple agents orchestrated by a single attacker using a handler;

FIG. 2 depicts an exemplary embodiment of a flow chart depicting an exemplary intelligence user authentication test according to the present invention;

FIG. 3 depicts an exemplary embodiment of an application service provider (ASP) providing an intelligence test service to a web server according to the present invention;

FIG. 4 depicts an exemplary embodiment of a computer system that can be used to implement the present invention; and

FIG. 5 depicts an exemplary embodiment of a graphical user interface (GUI) of an intelligence test according to the present invention.

### DETAILED DESCRIPTION OF AN EXEMPLARY EMBODIMENT OF THE PRESENT INVENTION

A preferred embodiment of the invention is discussed in detail below. While specific exemplary implementation embodiments are discussed, it should be understood that this is done for illustration purposes only. A person skilled in the relevant art will recognize that other components and configurations may be used without parting from the spirit and scope of the invention.

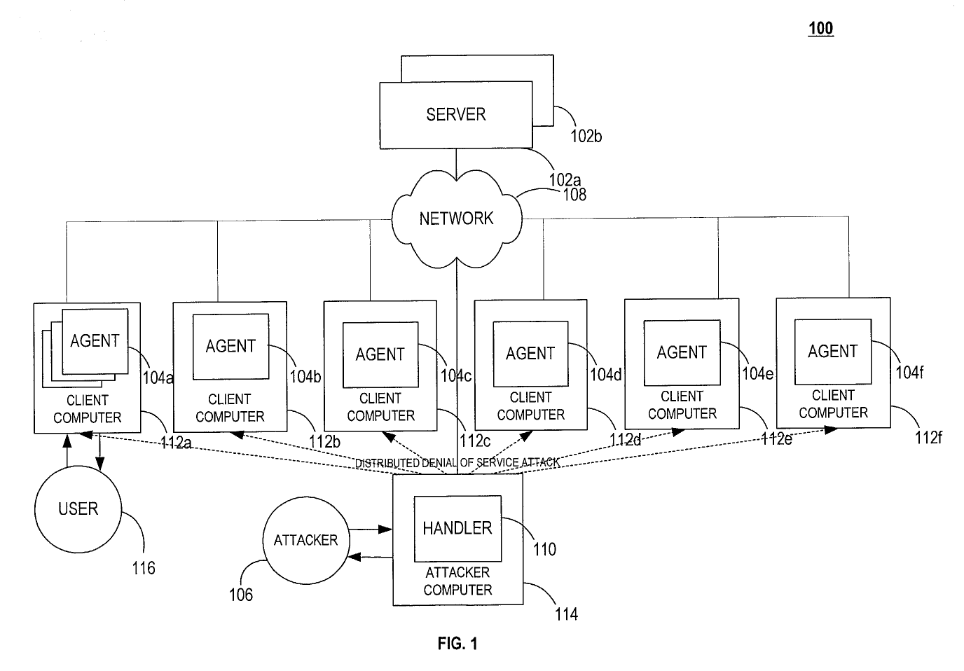

FIG. 1 depicts an exemplary embodiment of a distributed denial of service (DDoS) attack 100 of a server 102a, 102b over a network 108 by multiple agents 104a-104f executed on client computers 112a-112f, respectively, operated by users 116a-116f, orchestrated by a single attacker 106 using a handler 110 on a computer system 114 of the attacker.

In an exemplary embodiment of the present invention, an intelligence test can be provided to each of the users 116a-f at client computers 112a-f to ascertain the validity of the user during a distributed denial of service (DDoS) attack 100.

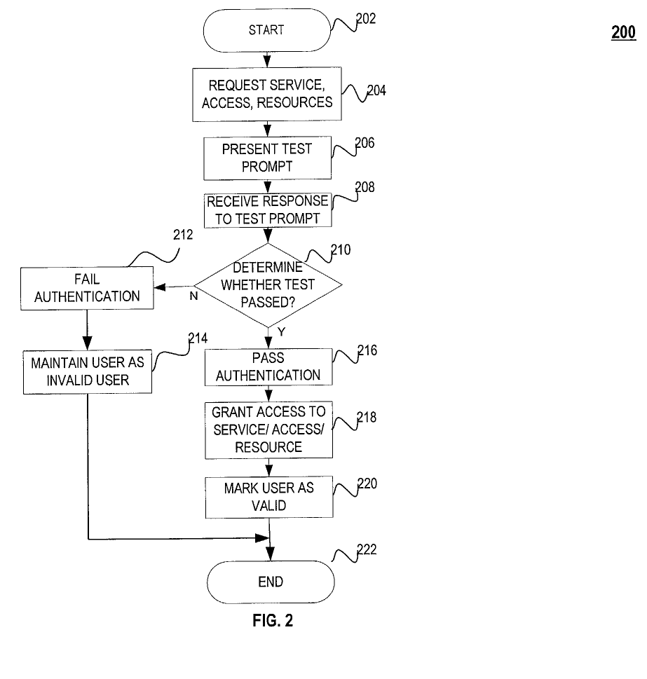

In an exemplary embodiment, the intelligence authentication test of the present invention can include a series of processing steps such as, e.g., those appearing in exemplary test 200 of FIG. 2 described further below.

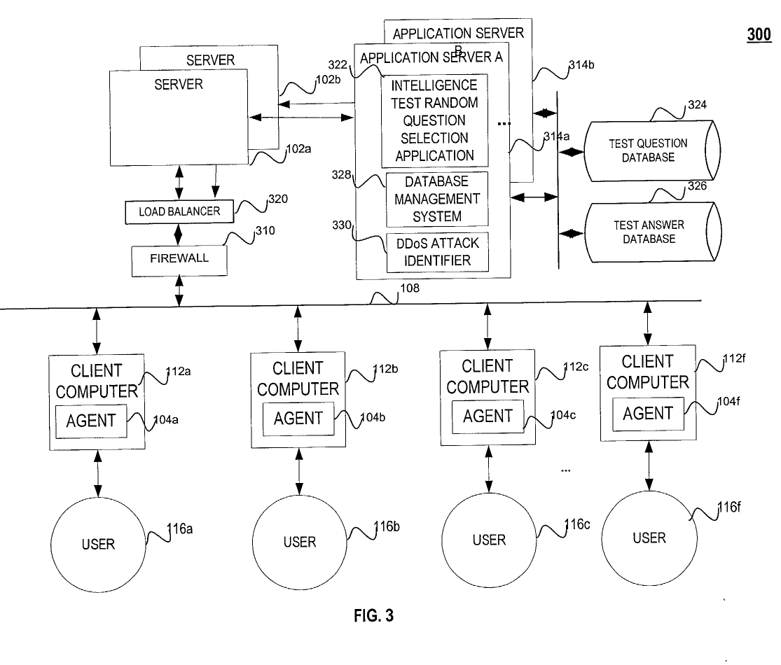

In an exemplary embodiment, the intelligence test of the present invention can be a subset of a more comprehensive DDoS solution. In an exemplary embodiment, the intelligence test can be part of a system bundle that can include any of, e.g., a firewall, a computer system, a console, an operating system, a subscription service, and a system for selecting questions and answers such as depicted in the exemplary embodiment of FIG. 3 described further below.

In an exemplary embodiment of the present invention, a significant amount of bad traffic from the DDoS attack can have already have been blocked by other conventional countermeasures.

Since DDoS attacks are fairly new DDoS attacks can be relatively easy to detect. However, it is anticipated that in the near future DDoS attacks will become more complex as countermeasures become more complex. Because the DDoS attacks 100 are expected to evolve with new the countermeasures, it is anticipated that requests from attacking agents 104a-104f will eventually become virtually indistinguishable from legitimate usage requests.

In an exemplary embodiment of the present invention, the attack can be similar to the DDoS attacks of today, but the attack can be anticipated to be more advanced in the type of data that the attacker can use in the attack.

FIG. 1 depicts an exemplary embodiment of a block diagram illustrating an exemplary DDoS attack 100. In an exemplary embodiment, an attacker 106 can use more advanced types of data than are presently being used today. The attacker 106 can have installed a large number of attack agents 104a-104f that can have a central authority, i.e., handler 110. The agents 104a-104f can be programmed with a number of different attack capabilities such as, e.g., SMURF, ICMP ECHO, ping flood, HTTP and FTP.

The attacks 100 of greatest interest at the time of writing are HTTP and FTP attacks. Other types of attacks can be able to be blocked using other methods. The HTTP attack can include an agent 104 browsing a web server 102 and requesting high volumes of load pages and can include having the agent 104 enter false information into any online forms that the agent 104a-104f of attacker 106 finds. The attack can include a large volume of page loads and can be particularly dangerous to sites that dynamically generate content because there can be a large CPU cost in generating a dynamic page.

The attacker 106 in another exemplary embodiment could use handler 110 to pick key points of interest to focus on during the attack such as, e.g., the search page, causing thousands of non-valid user searches to be sent per second. Other points of interest can include customer information pages where the attacker 106 can have the agents 104a-104f enter seemingly realistic information, to poison the customer information database with invalid data.

The present invention can be helpful where a particular page contains a large amount of information, and agents 104a-104f request the page various times. In another exemplary embodiment, the present invention can be used to overcome an attack, where a requested page can include a form that the agents 104a-104f can fill in with false information, thus attempting to poison the database of the server 102.

In an exemplary embodiment, agents 104a-104f can be scripted agents. Scripted agents 104a-104f are often unintelligent software programs. The scripted agents 104a-104f, as unintelligent software programs, can typically only send what can appear to a server 102 as a normal request, at a set time. The agents 104a-104f do not have the intelligence of a user 116.

An FTP attack can include, e.g., a multiple number of agents 104a-104f downloading and uploading files.

FIG. 2 depicts an exemplary embodiment of a flow chart 200 depicting an exemplary intelligence user authentication test according to the present invention.

Flow chart 200, in an exemplary embodiment can begin with step 202 and can continue immediately with step 204. Suppose, in the exemplary embodiment, that a DDoS attack has been identified by a DDoS attack identifier 330, or is suspected because of a sudden increase in response time or other indication of attack. When a DDoS attack is identified, then the process of FIG. 200 can be used to screen for valid users.

In step 204, a user 116a can send a request for service to a server 102a, 102b, by using a client computer 112a, for example. The user 116a could be using an Internet browser to access a web page identified by a universal resource locator (URL) identifier over network 108 on a server 102a, 102b. From step 204, flow diagram 200 can continue with step 206.

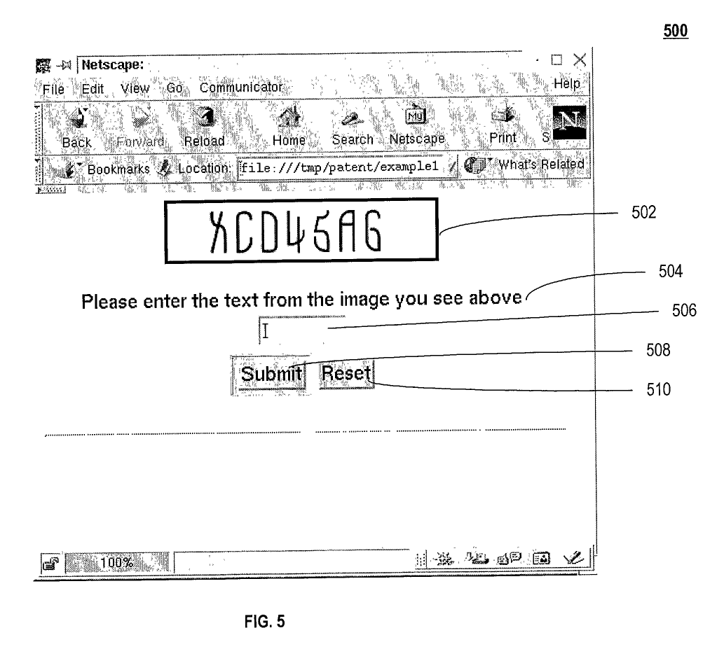

In step 206, the system of the present invention can generate a test question, or select a test question from pre-generated test questions and can present the test question to the user for authentication. For example, the user 116 can be presented with a test such as that shown in FIG. 5 of the present invention. The test can include, e.g., a piece of content, a question, and an input location for the user 116 to demonstrate that the user is a valid user. In an exemplary embodiment, the test can be a “Turing” test that can be designed to determine whether the user 116 is a software scripted agent 104 or a valid user 116. An example of a test is described below with reference to FIG. 5 below. If the user is actually a scripted agent 104, then the agent 104 will not be able to respond to the test intelligently, i.e., it can only execute a set script of commands. The present invention uses a test of intelligence to push onto the attacker 106, a much more difficult task in order to attack the server 102. From step 206, flow diagram 200 can continue with step 208.

In step 208, the user 116 can provide a response to the test question prompted in question 206. For example, the user 116a can enter the answer to a question into the user's computer 112a. The user 116a will be somewhat inconvenienced by having to authenticate, but the inconvenience will be preferred versus having no access because of inaccessibility caused by the DDoS attack. From step 208, flow diagram 200 can continue with step 210.

In step 210, the present invention can determine whether the user 116 passed the test or not. If the user 116 passed the test, then processing can continue with step 216 and can continue immediately with step 218. If the user 116 does not pass the test, then processing of flow chart 200 can continue with step 212 meaning the authentication failed. In the exemplary embodiment, flow diagram 200 can continue with step 214. In an alternative embodiment, the user 116 can be given one or more additional opportunities to attempt to complete the test.

In step 218, the user 116 can be granted access to the originally requested service, or resource on the server 102a, 102b. From step 218, the flow diagram 200 can continue with step 220.

In step 220, the user 116 can be marked as a valid user. In an exemplary embodiment, the user 116 marked as a valid user can be provided a number of future accesses to the resources of servers 102a, 102b without a need to reauthenticate. From step 220, the flow diagram 200 can continue immediately with step 222.

In step 214, in an exemplary embodiment, all users can be initially assumed to be invalid. In step 214, the user can be maintained as invalid and the status of the requesting user 116 can be stored. In an alternative embodiment, the user, since having failed the authentication can be restricted from access for a set number of requests. From step 214, flow diagram 200 can continue with step 222.

In an exemplary embodiment, the countermeasure of the present invention can be included as part of a multi-level defense. The first level of defense, in an exemplary embodiment could defend against SMURF, ICMP and other TCP/IP level attacks.

The countermeasure described above and depicted in the exemplary embodiment of FIG. 2 could be situated behind a first level of defense. In one exemplary embodiment, the system could be a small piece of hardware that could be situated upstream of the site to be protected. In another exemplary embodiment, the system of the present invention could be a software program running on the same or another computer than the server 102. In yet another exemplary embodiment, the present invention can be part of a subscription service. In another exemplary embodiment, the present invention can be provided as an application service provider (ASP) solution to various websites as depicted in FIG. 3.

In an exemplary embodiment, when an attack is detected by a DDoS attack identifier 330, e.g., because of an identification of a dramatic increase in bandwidth utilization, or an increase in web server load, then the multi-level defense can be activated.

A list of valid users 116 can be maintained in the system of FIG. 3, for example. Each time a valid user is identified using the process illustrated in FIG. 2, the valid user can be added to a list of valid users and can be allowed access to the resources of the server 102 for a period of time.

The first level of defense, in an exemplary embodiment, can remove all protocol level attacks. The first level of defense could then leave the present invention to distinguish between invalid and valid hypertext transfer protocol (HTTP) and file transfer protocol (FTP) users. The first time a request is made to an HTTP or FTP server by a user, the user can be presented with a question to test for human intelligence. An exemplary embodiment of an intelligence test appears in FIG. 5.

Once the user 116 has passed the test, access can be allowed to the requested site of the server 102. The access control described in an exemplary embodiment of the present invention can use a list, although cookies could also be used to identify valid users 116. Once a user 116 is validated, the system can let the user access the web site, indefinitely or for a certain period of time.

The question or test posed to the user 116 can be changed often, in an exemplary embodiment, in order to make it difficult for the attacker 106 to reprogram the agents 104a-104f to deal with the test questions. A list of questions could be maintained in a database as shown in the exemplary embodiment of FIG. 3.

FIG. 3 depicts an exemplary embodiment of a block diagram 300 of an application service provider (ASP) providing an intelligence test service to one or more web servers 102 according to the present invention. The block diagram 300 illustrates an exemplary embodiment of an implementation of the present invention. Specifically, block diagram 300 depicts an exemplary embodiment of a system that can be used to identify a DDoS attack and to provide ongoing services to intercede and provide test questions and authenticate user responses according to an exemplary implementation of the present invention. Block diagram 300 can include, e.g., one or more users 116a-116f interacting with one or more client computer systems 112a-112f. Although the client computers 112a-112f can include agents 104a-104f, an intelligence test system application server 314a, 314b can provide services to servers 102a, 102b to intercede during or to prevent a DDoS attack. The client computers 112a, 112b can be coupled to a network 108, as shown.

Block diagram 300 can further include, e.g., one or more users 116a, 116b interacting with one or more client computers 112a-112f. The client computers 112a-112f can be coupled to the network 108. Each of computers 112a-112f can include a browser (not shown) such as, e.g., an internet browser such as, e.g., NETSCAPE NAVIGATOR available from America Online of Vienna, Va., U.S.A., and MICROSOFT INTERNET EXPLORER available from Microsoft Corporation of Redmond, Wash., U.S.A., which can be used to access resources on servers 102a, 102b. In the event an attacker 106 places agents 104a-104f onto client computers 112a-112f, respectively, then requests for resources or other access can be sent over network 108, over, e.g., a firewall 310, and a load balancer 320 to be responded to by servers 102a, 102b.

In the exemplary embodiment, application servers 314a, 314b can perform an identification process determining whether servers 102a, 102b are under a DDoS attack based on occurrence of certain criteria. The identification process can be performed in the exemplary embodiment by DDoS attack identifier module 330 that is shown as part of application server 314a. Alternatively, the identifier module 330 could be part of server 102a, 102b, firewall 310, or any other computing device or system.

In an exemplary embodiment, application server 314a, 314b can include a database management system (DBMS) 328 that can be used to manage a database of test questions 324 and a database of test answers 326, as shown in the exemplary embodiment. Any other database 324, 326 could also be used, or a combined database including the data of databases 324, 326, as will be apparent to those skilled in the relevant art. Alternatively, the databases can be stored on another computer, communication device, or computer device such as, e.g., server 102a, 102b, or firewall 310.

An intelligence test random question selection application module 322 is shown in the exemplary embodiment that can select a question from question database 324 of the present invention. In one embodiment, questions can be selected randomly using module 322. In another exemplary embodiment, questions can be selected from a sequence instead of randomly. In an exemplary embodiment, the module 322 can prompt the users 116a-116f when a request is received. In one exemplary embodiment, module 322 can perform some of the steps of FIG. 2 described above. The module 322, e.g., can compare an expected answer obtained from the test answer database 326 with a response received from a user 116a responding to an intelligence test question previously prompted to the user 116a, where the question was selected from test question database 324. As will be apparent to those skilled in the relevant art, the module 322 can also be included alternatively, in other exemplary embodiments in other computing and communication devices such as, e.g., servers 102a, 102b, and firewall 310. Alternatively, the module 322 can be included as part of an operating system, or as part of a router or other communications or computing device.

All the computers 112a-112f and servers 102a, 102b, 314a, 314b and databases 324, 326 can interact with the system of the present invention according to conventional techniques and using one or more networks 108 (not necessarily shown in the diagram 300).

In an exemplary embodiment of the present invention, requests from a client computer 112a-112f can be created by users 116a-116f, using, e.g., browsers (not shown) to create, e.g., hypertext transfer protocol (HTTP) requests of an identifier such as, e.g., a universal resource locator (URL) of a file on a server 102a, 102b. Incoming requests from the client computers 112a-112f can go through the firewall 310 and can be routed via, e.g., load balancer 320 to one of servers 102a, 102b. The servers can provide, e.g., session management with the client computers 112a-112f. The requests can be intercepted during a DDoS attack and the intelligence test of the present invention can be presented to authenticate the user 116a as a valid user, according to the present invention.

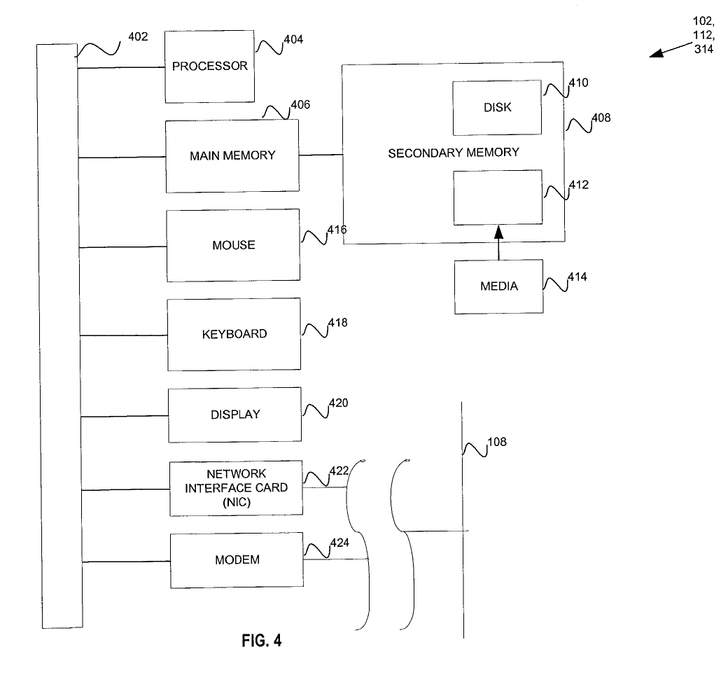

FIG. 4 depicts an exemplary embodiment of a computer system 102, 112, 314 that can be used to implement the present invention. Specifically, FIG. 4 illustrates an exemplary embodiment of a computer 102, 112, 314 that in an exemplary embodiment can be a client or server computer that can include, e.g., a personal computer (PC) system running an operating system such as, e.g., Windows NT/98/2000, LINUX, OS/2, Mac/OS, or other variant of the UNIX operating system. However, the invention is not limited to these platforms. Instead, the invention can be implemented on any appropriate computer system running any appropriate operating system, such as Solaris, Irix, Linux, HPUX, OSF, Windows 98, Windows NT, OS/2, Mac/OS, and any others that can support Internet access. In one embodiment, the present invention can be implemented on a computer system operating as discussed herein. An exemplary computer system, computer 102, 112, 314 is illustrated in FIG. 4. Other components of the invention, such as, e.g., other computing and communications devices including, e.g., client workstations, proxy servers, routers, firewalls, network communication servers, remote access devices, client computers, server computers, routers, web servers, data, media, audio, video, telephony or streaming technology servers could also be implemented using a computer such as that shown in FIG. 4.

The computer system 102, 112, 314 can also include one or more processors, such as, e.g., processor 402. The processor 402 can be connected to a communication bus 404.

The computer system 102, 112, 314 can also include a main memory 406, preferably random access memory (RAM), and a secondary memory 408. The secondary memory 408 can include, e.g., a hard disk drive 410, or storage area network (SAN) and/or a removable storage drive 412, representing a floppy diskette drive, a magnetic tape drive, a compact disk drive, etc. The removable storage drive 412 reads from and/or writes to a removable storage unit 414 in a well known manner.

Removable storage unit 414, also called a program storage device or a computer program product, represents a floppy disk, magnetic tape, compact disk, etc. The removable storage unit 414 includes a computer usable storage medium having stored therein computer software and/or data, such as an object's methods and data.

Computer 102, 112, 314 can also include an input device such as, e.g., (but not limited to) a mouse 416 or other pointing device such as a digitizer, and a keyboard 418 or other data entry device.

Computer 102, 112, 314 can also include output devices, such as, e.g., display 420. Computer 102, 112, 314 can include input/output (I/O) devices such as, e.g., network interface cards 422 and modems 424.

Computer programs (also called computer control logic), including object oriented computer programs, can be stored in main memory 406 and/or the secondary memory 408 and/or removable storage units 414, also called computer program products. Such computer programs, when executed, can enable the computer system 102, 112, 314 to perform the features of the present invention as discussed herein. In particular, the computer programs, when executed, can enable the processor 402 to perform the features of the present invention. Accordingly, such computer programs represent controllers of the computer system 102, 112, 314.

In another embodiment, the invention is directed to a computer program product including a computer readable medium having control logic (computer software) stored therein. The control logic, when executed by the processor 402, can cause the processor 402 to perform the functions of the invention as described herein.

In yet another embodiment, the invention can be implemented primarily in hardware using, e.g., one or more state machines. Implementation of these state machines so as to perform the functions described herein will be apparent to persons skilled in the relevant arts.

FIG. 5 depicts an exemplary embodiment of a graphical user interface (GUI) 500 of an exemplary intelligence test according to the present invention.

GUI 500 includes an exemplary embodiment of an intelligence test which can include, e.g., an image or other content 502 that can provide a challenge that is difficult for an agent 104 computer program to solve, and a question 504 prompting and querying input from the user 116 in an input field 506. In the exemplary embodiment, the user 116 can enter a response into input field 506 and can submit the request by selecting a button 508. GUI 500 also shows a reset button 510 in the exemplary embodiment. The question 504 can be stored in a test question database 324 in one exemplary embodiment.

In another exemplary embodiment, the intelligence test image 502 can be generated by a test generation module (not shown) that can create a test of difficulty sufficient to prevent attacking agents 104 from passing the tests. For example, the test generation module can, in an exemplary embodiment, generate a random numeric or alphanumeric string. Then a graphical image 502 can be rendered illustrating the image in a font that can be generated so as not to be easily recognized using image recognition technology. Alternatively, the information can be provided in another form uneasily recognized by a scripted agent 104, such as, e.g., in audio form. In the exemplary embodiment, the random numeric or alphanumeric string can be stored for later comparison to an inputted answer received from the user 116 or agent 104, to determine whether the test was passed. The answer can be stored in a test answer database 326 in an exemplary embodiment.

Artificial intelligence continues to improve over time so new intelligence test questions can be continually developed to outdistance the developers of agent 104 software. In an exemplary embodiment, a subscription based service similar to an antivirus service can be offered to web developers and developers of other content for servers 102.

In an exemplary embodiment, the test can be a Turing test.

Named for the British mathematician Alan Turing, The Turing Test developed in the 1950s is a milestone in the history of the relationship between humans and machines. Alan Turing described an “imitation game” designed to answer a question, “If a computer could think, how could humans know?” Turing recognized that if, in a conversation, a computer's responses were indistinguishable from a human's, then the computer (according to Turing) could be said to “think.” Thus, a Turing Test can be a test of intelligence of a computer, i.e., how close the computer is to a human's intelligence. The imitation game was intended to require a computer to sustain a human-style conversation in a strictly controlled, blind test, long enough to fool a human judge. Turing predicted that a computer would be able to “pass” the test within fifty years. The Loebner prize is a $100,000 award for the computer that can pass a version of the Turing test. No computer has yet been built that can pass the Turing test posited by Alan Turing. The Turing Test relates to the progress of computer intelligence.

When a computer convinces a human judge that it is, or is indistinguishable from, a human, then the computer will have passed the Turing test. Basically, the Turing test is a test for artificial intelligence. Turing concluded that a machine could be seen as being intelligent if it could “fool” a human into believing it was human.

The original Turing Test involved a human interrogator using a computer terminal, which was in turn connected to two additional, and unseen, terminals. At one of the “unseen” terminals is a human; at the other is a piece of computer software or hardware written to act and respond as if it were human. The interrogator would converse with both human and computer. If, after a certain amount of time (Turing proposed five minutes, but the exact amount of time is generally considered irrelevant), the interrogator cannot decide which terminal is the machine and which the human, the machine is said to be intelligent.

This test has been broadened over time, and generally a machine is said to have passed the Turing Test if the machine can convince the interrogator that the machine is human, without the need for a second human.

The Blurring Test conceived of in 1998 turns the Turing Test on its head and challenges humans to assert their humanity rather than the computer to assert intelligence.

In the context of the present invention, a Turing test refers to the broader definition of the Turing test, that tests the intelligence of an agent 104, in order to distinguish between a valid intelligent human user 116 and an attacking unintelligent scripted agent 104. If the requesting user can pass the Turing test of the present invention, then the user 116 will be granted access to the server resources. In a sense, the intelligence test of the present invention is like a blurring test in that a human user 116 asserts its humanity by answering the question of the test. Since the agent 104 can not answer the intelligence test, the agent 104 cannot assert its humanity and thus will not be granted access to the requested resource.

Specifically, the Turing test of the present invention uses a computer to determine whether a requester of resources is a human user 116 or a computer software agent 104. If the test is passed, then the computer of the present invention assumes that the requestor is a valid human user 116.

In an exemplary embodiment, the test can include a graphical image, about which the user 116 can answer a question. Since the agent 104 is not a person, the agent 104 can not view the image (without the use of, e.g., a sophisticated optical character recognition (OCR) capability, then the lack of intelligence of the agent 104 can stop the attack.

The test could include, e.g., content, audio, video, a graphic image, a sound, a moving image, image recognition, a scent, basic arithmetic, manipulating objects, moving a red object over a blue object. The amount of intelligence needed to perform the test will continually increase as artificial intelligence (AI) evolves.

The test raises the bar for an attacker 106 to have to overcome in order to access network or server resources.

The present invention can be included as part of a firewall, a web server, or transparently anywhere between a server and a client, such as, e.g., at a router, or a firewall. The present invention can run on a web server as a module, as an application, or as a script. The present invention could also be integrated into a specialized device.

In an exemplary embodiment, the present invention can also be included as part of a multi-level defense. For example, a first level of defense could filter certain types of attacks which might be easier to identify and block. A Turing test of the intelligence of a user could then be used as a second level of defense to authenticate users 116 that have passed the first level of defense. Valid users 116 can be provided an access token, or can be provided access for a period of time and agents 104 which will not pass the test can be blocked from gaining access to the resources of the server 102.

In an exemplary embodiment, in order to be able to answer the questions of the test of the present invention, the user 116 will need to have a certain level of intelligence to answer the test question. The answers to the test question can be used by a system to differentiate between requests from non-valid user agents 104 and requests from valid users 116. Once a test is passed, the user 116 can be provided access to server 102 resources for a period of time. Since it is possible that a later request could have originated from an agent 104, an intelligence test can be offered at a later time to reauthenticate user 116.

The exemplary embodiment of FIG. 5 illustrates an intelligence test that can be presented to the user 116 of an http type intelligence test, administered using an exemplary browser.

Since the FTP protocol does not offer a means to display a question, in an exemplary embodiment, the first attempt to access the FTP server could display an error message redirecting the user to a web interface from which the user 116 could be validated. For example, upon connecting to the FTP server the user 116 could receive an error that states that, “Due to technical difficulties we require that you be validated. To be validated please visit http://www.website.com/validate. Upon being validated try again.”

By using an intelligence test to separate attack agents from valid users, the present invention can offer a solution that can significantly reduce the number of invalid users. The solution of the present invention would hopefully increase availability of the web server during an attack by allowing the users to continue to access the site. A Turing test could also be used to control access to other application programs such as, e.g., software, or computer games.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method of controlling access to resources comprising:
(a) receiving a request from an entity;
(b) presenting said entity with a test;
(c) determining from said test whether or not said entity is an intelligent being; and
(d) granting said request only if said entity is determined to be an intelligent being.

2. The method according to claim 1, wherein said step (a) comprises:
(1) receiving a request for at least one of services, access and resources from said entity.

3. The method according to claim 2, wherein said step (1) comprises:
(A) receiving a request for at least one of network services, network access, computer system storage, processor and memory resources from said entity.

4. The method according to claim 1, wherein said step (b) comprises:
(1) presenting said entity with an intelligence test.

5. The method according to claim 4, wherein said step (1) comprises:
(A) presenting said entity with at least one of a nationality test, an intelligence test, and a Turing test.

6. The method according to claim 5, wherein said step (A) comprises:
(i) presenting said entity with at least one of a 2D or 3D graphical image, language, words, shapes, operations, a sound, a question, a challenge, a request to perform a task, content, audio, video, and text.

7. The method according to claim 1, wherein said steps (a-d) comprise a second level of security, and wherein a first level of security comprises:
(1) filtering said request for known invalid requests.

8. The method according to claim 1, wherein said step (a) comprises:
(1) receiving a request from a protocol providing for interaction with an intelligent being, including at least one of:
hypertext transport protocol (http);
file transfer protocol (ftp);
simple mail transfer protocol (smtp);
chat;
instant messaging (IM);
IRC;
Windows messaging protocol; and
OSI Application layer applications.

9. The method according to claim 1, wherein said step (d) comprises:
(1) denying access to said request for at least one of scripted agents during a distributed denial of service attack, and invalid entities.

10. The method according to claim 1, wherein the method comprises
(e) updating said test to overcome advances in artificial intelligence of agents.

11. The method according to claim 10, wherein said step (e) comprises:
(1) providing a subscription to test updates.

12. The method according to claim 1, further comprising:
(e) generating said test comprising
(1) generating a test and an expected answer, and
(2) storing an expected answer for comparison with input from said entity.

13. A system that controls access to resources comprising:
a processor operative to receive a request from an entity, to present the entity with a test, and to grant said request only if said test determines whether the entity is an intelligent being.

14. The system according to claim 13, wherein said a request comprises at least one of:
network services;
network access;
computer system storage resources;
processor resources; and
memory resources.

15. The system according to claim 13, wherein said test comprises: at least one of
an intelligence test, a nationality test, a Turing test, content, audio, video, sound, a 2D or 3D graphical image, language, words, shapes, operations, text, a question, and directions to perform at least one of an action and an operation.

16. The system according to claim 13, wherein said test comprises a second level of security, and wherein a first level of security comprises:
a filter that identifies invalid requests for resources.

17. The system according to claim 13, wherein the system comprises an update that provides updated tests that overcome advances in artificial intelligence of agents.

18. The system according to claim 13, further comprising:
a random test generator that determines an expected answer to said test;
a memory that stores said expected answer;
a test generator that renders said test; and
a comparator that compares said expected answer with an answer to a question inputted by the entity in response to said test.

19. The system according to claim 18, wherein said random test generator is operative to at least one of
encrypt said expected answers;
send said expected answers to the entity; and
represent said expected answers in another fashion to the entity.

20. A computer program product embodied on a computer readable media having program logic stored thereon that controls access to resources, the computer program product comprising:
program code means for enabling a computer to receive a request from an entity;
program code means for enabling the computer to present said entity with a test;
program code means for enabling the computer to determine from said test whether or not said entity is an intelligent being; and
program code means for enabling the computer to grant said request only if said entity is determined to be an intelligent being.

21. A system that controls access to resources comprising:
a firewall comprising:
a processor operative to receive a request for resources from an entity, to present said entity with a test, and to grant said request for resources only if said test determines said entity is an intelligent being.
